(19) United States
(12) Patent Application Publication
(10) Pub. No.: US 2007/0146285 A1
(43) Pub. Date: Jun. 28, 2007

(54) Voltage adjusting circuit and method of liquid crystal display panel

(75) Inventor: Yi-Chang Lai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/642,153

(22) Filed: Dec. 20, 2006

(30) Foreign Application Priority Data
Dec. 23, 2005 (TW) 94146343

(51) Int. Cl. G09G 3/36

(52) U.S. Cl. 345/98

(57) ABSTRACT

An exemplary voltage adjusting circuit (100) of an LCD panel includes a first input port (1), a second input port (2), a database (3), a voltage adjusting unit (4), a first buffer (6), a second buffer (7), a first output port (8), and a second output port (9). The database includes optimum voltage level therein. The first and second input ports respectively supplies data and common voltages into the database, and the database compares the data and common voltages to the optimum voltage level and outputs an adjusting signal to the voltage adjusting unit according to the result of the comparison. The voltage adjusting unit adjusts the voltage according to the adjusting signal, and outputs adjusted data voltage to the first output port via the first buffer, and outputs adjusted common voltage to the second output port via the second buffer.

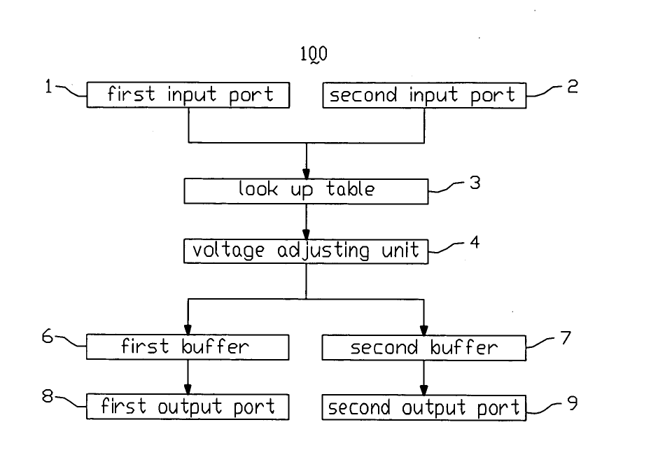

### FIELD OF THE INVENTION

The present invention relates to adjusting circuits, and particularly to a circuit and a method for adjusting voltage in a liquid crystal display panel.

### BACKGROUND

During the process of assembly of a liquid crystal display panel, the cell gap thereof is frequently uneven. An uneven cell gap can create a situation where the voltage level of the common electrode in different parts of the liquid crystal panel is different. Therefore, the liquid crystal display panel is liable to suffer from flickering. That is, it is important to adjust the liquid crystal display so as to reduce and/or eliminate flickering. A standard integrated driving circuit for driving the liquid crystal display panel cannot perform this function.

A conventional method for reducing and/or eliminating flickering in a liquid crystal display panel is to perform an adjustment of the liquid crystal display panel manually. A human operator can reduce and/or eliminate flickering in the liquid crystal display panel by adjusting electrical resistance in the liquid crystal display panel. Thereby, a voltage of the liquid crystal display panel is changed to an optimum voltage at which flickering is minimal or even nonexistent.

However, the manual adjusting process unduly complicates the process of fabricating the liquid crystal display panel. Moreover, evaluation of the level of flickering of the liquid crystal display panel by an operator is subject to human error.

Accordingly, what is needed is a voltage adjusting circuit and method that can overcome the above-described deficiencies.

### SUMMARY

An exemplary voltage adjusting circuit of a liquid crystal display for reducing and/or eliminating flickering includes a first input port, a second input port, a database, a voltage adjusting unit, a first buffer, a second buffer, a first output port, and a second output port. The database includes optimum voltage levels for reducing and/or eliminating flickering therein. The first and second input ports respectively supply a current data voltage and a current common voltage of the liquid crystal display to the database, and the database compares the current data voltage and the current common voltage to the optimum voltage levels and outputs an adjusting signal to the voltage adjusting unit according to a result of the comparison. The voltage adjusting unit adjusts the current data voltage and the current common voltage according to the adjusting signal, and outputs an adjusted data voltage to the first output port via the first buffer and an outputs adjusted common voltage to the second output port via the second buffer.

One method for adjusting voltage of a liquid crystal display panel includes: providing a data voltage and a common voltage into the liquid crystal display panel; comparing the data voltage with optimum voltage level; adjusting the data voltage according to the comparison result; and outputting the adjusted data voltage and the common voltage for displaying images on the liquid crystal panel.

Another method for adjusting voltage of a liquid crystal display panel, includes: providing a data voltage and a common voltage into the liquid crystal display panel; comparing the common voltage with optimum voltage level; adjusting the common voltage according to the result of the comparison; outputting the adjusted common voltage and the data voltage for displaying images on the liquid crystal panel.

Other advantages and novel features will become apparent from the following detailed description of preferred embodiments when taken in conjuction with the accompanying drawing.

### BRIEF DESCRIPTION OF THE DRAWING

The drawing is a block diagram of a voltage adjusting circuit according to an exemplary embodiment of the present invention.

### DETAILED DESCRIPTION OF PREFERRED EMBODIMENTS

Reference will now be made to the drawings to describe the preferred embodiments in detail.

Referring to the drawing, a block diagram of a voltage adjusting circuit according to an exemplary embodiment of the present invention is shown. The voltage adjusting circuit 100 includes a first input port 1, a second input port 2, a database 3, a voltage adjusting unit 4, a first buffer 6, a second buffer 7, a first output port 8, and a second output port 9.

The database 3 may include a look-up table, which includes optimum voltage level information therein. The optimum voltage level information includes optimum data voltage level and optimum common voltage level. The first and second input ports 1 and 2 respectively supply a data voltage and a common voltage to the database 3. The database 3 compares the data voltage and the common voltage to the optimum data voltage level and the optimum common voltage level respectively, and then outputs an adjusting signal to the voltage adjusting unit 4 according to the result of the comparison. The voltage adjusting unit 4 adjusts the voltage according to the adjusting signal, outputs an adjusted data voltage to the first output port 8 via the first buffer 6, and outputs an adjusted common voltage to the second output port 9 via the second buffer 7.

In a typical application, the voltage adjusting circuit 100 is utilized and located in a liquid crystal display panel. The first output port 8 is connected to a data driver of the liquid crystal display panel, and the second output port 9 is connected to another driver of the liquid crystal display panel.

The voltage adjusting circuit 100 can reduce and/or eliminate flickering in the liquid crystal display. Using a liquid crystal display panel having two display regions with different levels of flickering as an example, a detailed voltage adjusting process is as follows:

In a first exemplary situation, the common voltage is set at about 5 volts (V) and the data voltage is set at 3V for displaying an image on the liquid crystal display panel. Because of the different levels of flickering in the two display regions of the liquid crystal display panel, the brightness of the images may not meet with required levels of brightness. If the brightness of the first display region is less than the required brightness, then the data voltage is adjusted according to the optimum data voltage level in the database 3. For example, the original data voltage 3V can be adjusted to 2V. If the brightness of the second display region is greater than the required brightness, then the data voltage is adjusted according to the optimum data voltage level in the database 3. For example, the original data voltage 3V can be adjusted to 4V.

In a second exemplary situation, the data voltage is set at 3V, and the common voltage is set at 5V for displaying an image on the liquid crystal display panel. Because of the different levels of flickering in the two display regions of the liquid crystal display panel, the brightness of the images may not meet the required levels of brightness. If the brightness of the first display region is less than the required brightness, then the common voltage is adjusted according to the optimum common voltage level in the database 3. For example, the original common voltage 5V can be adjusted to 6V. If the brightness of the second display region is greater than the required brightness, then the common voltage is adjusted according to the optimum common voltage level in the database 3. For example, the original common voltage 5V can be adjusted to 4V.

In a third exemplary situation, the data voltage is set at 3V and the common voltage is set at 5V for displaying an image on the liquid crystal display panel. Because of the different levels of flickering in the two display regions of the liquid crystal display panel, the brightness of the images may not meet with the required levels of brightness. If the brightness of the first display region is less than the required brightness and the brightness of the second display region is greater than the required brightness, both the data voltage and common voltage can be adjust to ensure that the brightness level meets with the required levels of brightness. For example, the data voltage of the first display region can be adjusted to 2.5V and the data voltage of the second display region can be adjusted to 3.5V according to the optimum voltage level information in the database 3; and together with such adjustments, the common voltage of the first display region can be adjusted to 5.5V and the common voltage of the second display region can be adjusted to 4.5V according to the optimum common voltage level information in the database 3.

The voltage adjusting circuit and method can be applied to liquid crystal displays with all kinds of levels of flickering, and is not limited to a liquid crystal display with two different levels of flickering in two display regions thereof.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A voltage adjusting circuit of a liquid crystal display, comprising: a first input port, a second input port, a database, a voltage adjusting unit, a first buffer, a second buffer, a first output port, and a second output port;
wherein the database stores optimum voltage levels therein, the first and second input ports respectively supply a current data voltage and a current common voltage of the liquid crystal display to the database, the database compares the current data voltage and the current common voltage to the optimum voltage levels and outputs an adjusting signal to the voltage adjusting unit according to a result of the comparison, and the voltage adjusting unit adjusts the current data voltage and the current common voltage according to the adjusting signal, and outputs an adjusted data voltage to the first output port via the first buffer and an adjusted common voltage to the second output port via the second buffer.

2. The voltage adjusting circuit as claimed in claim 1, wherein the optimum voltage levels include an optimum data voltage level and an optimum common voltage level.

3. The voltage adjusting circuit as claimed in claim 1, wherein the database comprises a look-up table.

4. A circuit based method for adjusting voltage of a liquid crystal display panel, comprising:
providing a current data voltage and a current common voltage to a memory of the liquid crystal display panel;
comparing the current data voltage with an optimum data voltage level stored in the memory;
adjusting the current data voltage according to a result of the comparison; and
outputting the adjusted data voltage and the current common voltage for displaying of images by the liquid crystal panel.

5. A circuit based method for adjusting voltage of a liquid crystal display panel, comprising:
providing a current data voltage and a current common voltage to a memory of the liquid crystal display panel;
comparing the current common voltage with an optimum common voltage level stored in the memory;
adjusting the current common voltage according to a result of the comparison; and
outputting the adjusted common voltage and the current data voltage for displaying of images by the liquid crystal panel.

6. The method as claimed in claim 5, further comprising comparing the current data voltage with an optimum data voltage level stored in the memory at substantially the same time as comparing the current common voltage with the optimum common voltage level.

7. The method as claimed in claim 6, further comprising adjusting the current data voltage according to a result of the comparison of the current data voltage with the optimum data voltage level, at substantially the same time as adjusting the common voltage.

8. The method as claimed in claim 7, further comprising outputting the adjusted data voltage at substantially the same time as outputting the adjusted common voltage for displaying of images by the liquid crystal panel.
